(19) United States
(12) Patent Application Publication
(10) Pub. No.: US 2018/0219798 A1
(43) Pub. Date: Aug. 2, 2018

(54) Parallel Redundancy Protocol ("PRP") Bridge For A Single Attached Device

(71) Applicant: COOPER TECHNOLOGIES COMPANY, Houston, TX (US)

(72) Inventors: REMI DUTIL, QUEBEC (CA); RONALD LANDHEER, QUEBEC (CA)

(73) Assignee: COOPER TECHNOLOGIES COMPANY, Houston, TX (US)

(21) Appl. No.: 15/420,922

(22) Filed: Jan. 31, 2017

(51) Int. Cl. H04L 12/947; H04L 29/06; H04L 12/823; H04L 12/46; H04L 29/08

(52) U.S. Cl. CPC H04L 49/25; H04L 69/22; H04L 67/1095; H04L 69/14; H04L 12/4645; H04L 47/32

(57) ABSTRACT

Methods, devices, and systems for facilitating communications using a parallel redundancy protocol (“PRP”) bridge device are described herein. A PRP bridge device, in one embodiment, includes a first data port in communication with a first network, and a second data port in communication with a second network. Upon receiving a data packet at the first data port, the

PRP bridge device is structured to determine whether or not the data packet includes a PRP data tag. If so, then the data packet is discarded. If no PRP data tag is present within the data packet, and a value of an EtherType header of the data packet is one of the values that the PRP bridge is structured to accept, then the PRP bridge device is capable of sending, using the second data port, the data packet to the second network.

### BACKGROUND OF THE INVENTION

### Field

The present invention generally relates to a parallel redundancy protocol (“PRP”) bridge capable of coupling two independent redundancy networks. In particular, the PRP bridge allows a single attached device of one network to communicate with a single attached device of another network.

### Background Information

Various functionalities, such as those of power distribution systems and substations, for example, require substantially constant connectivity to prevent a loss of functionality. One way to prevent failures is by implementation of a parallel redundancy protocol (“PRP”), as defined by IEC 62439-3, clause 4, which is incorporated herein by reference in its entirety, which is implemented over two independent networks. In PRP networks, a data packet sent by a sending device is duplicated, and the original is sent to a destination across one of the networks, and the duplicate is sent to the destination across the other network. A receiving device accepts the first data packet that it receives, whether that data packet is the original or the duplicate, and discards the second data packet. In this way, even if one of the networks has a failure associated with it, the data packet will still be received at the destination.

PRP devices, which may also be referred to as dual attached device and/or dual access devices (both of which may be referred to by “DAD”), and/or dual attached nodes and/or dual access nodes (both of which may be referred to by “DAN”) include PRP protocols and are configured to be connected to two independent networks. The two networks, which may be switched networks, may include similar topologies, however this is not a requirement. Each network is powered independently of the other network so as to exclude the possibility of a power failure simultaneously affecting both networks.

Each network is capable of including one or more single attached devices/nodes (“SANs”) and one or more DANs. The SANs are attached to one network, while the DANs attach to both networks (in a two redundancy network topology). Additionally, a redundancy device, which sometimes may be referred to as a “RedBox,” may also be included. A redundancy device, as described herein, allows a SAN to access two networks. Some redundancy devices allow for two or more SANs to access two networks, albeit typically the more SANs included, the more redundancy devices needed.

There is a need for allowing two redundancy networks to be bridged together such that SANs of one network are able to access SANs of the other network. Furthermore, there is a need for reducing the number of redundancy devices needed within a redundancy network topology, or even eliminating the need for any redundancy devices.

### SUMMARY

These needs and others are met by embodiments of the disclosed concept, which are directed to methods and devices for employing a parallel redundancy protocol (“PRP”) bridge device to allow a single attached device of a redundancy network to communicate with another single attached device of another redundancy network.

As one aspect of the disclosed concept, a method is described. In a non-limiting embodiment, a first Ethernet data packet is capable of being received at a first data port of a parallel redundancy protocol (“PRP”) bridge device, where the first data port is coupled to a first network. The PRP bridge device is capable of determining that the first data packet corresponds to a non-PRP data packet and, using a second data port of the PRP bridge device, sends the first data packet to a second network coupled to the second data port.

As another aspect of the disclosed concept, a parallel redundancy protocol (“PRP”) bridge device is described. The PRP bridge device, in a non-limiting embodiment, includes a first data port coupled to a first network, a second data port coupled to a second network, memory, and at least one processor. The at least one processor is operable to determine that a first data packet was received by the first data port. The at least one processor is operable to determine that the first data packet corresponds to a non-PRP data packet, and cause the second data port to send the first data packet to the second network.

As yet another aspect of the disclosed concept, a system is described. The system includes, in a non-limiting embodiment, a first network including at least a first single attached device, a second network including at least a second single attached device, and a parallel redundancy protocol (“PRP”) bridge device. The PRP bridge device is structured to receive, at a first data port of the PRP bridge device, a first data packet, where the first data port is coupled to the first network. The PRP bridge device is further structured to determine that the first data packet corresponds to a non-PRP data packet, and cause, using a second data port of the PRP bridge device, the first data packet to be sent to the second network.

### BRIEF DESCRIPTION OF THE DRAWINGS

A full understanding of the disclosed concept can be gained from the following description of the preferred embodiments when read in conjunction with the accompanying drawings in which:

FIG. 1 is an illustrative schematic diagram of an exemplary system including two redundancy networks bridged by a PRP bridge device, in accordance with an embodiment of the disclosed concept;

FIG. 2 is an illustrative flowchart of an exemplary process for determining whether a data packet received by a first port of a PRP bridge device coupled to a first network is to be forwarded to a second port of the PRP bridge device coupled to a second network, in accordance with an embodiment of the disclosed concept;

FIG. 3 is illustrative schematic diagram of another exemplary system including two redundancy networks, where each redundancy network includes a switch including PRP bridge functionality, in accordance with an embodiment of the disclosed concept; and

FIG. 4 is an illustrative block diagram of an exemplary PRP bridge device, in accordance with an embodiment of the disclosed concept.

### DETAILED DESCRIPTION OF PREFERRED EMBODIMENTS

Directional phrases used herein, such as, for example, left, right, front, back, top, bottom, and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

As employed herein, the term “processor” shall mean a programmable analog and/or digital device that can store, retrieve, and process data; a computer; a workstation; a personal computer; a microprocessor; a microcontroller; a field-programmable gate array (“FPGA”); a complex programmable logic device (“CPLD”); a microcomputer; a central processing unit; a mainframe computer; a mini-computer; a server; a networked processor; or any suitable processing device or apparatus.

As employed herein, the singular form of “a”, “an”, and “the” include plural references unless the context clearly dictates otherwise.

As employed herein, a “transmitting” device or an “initiating” device refers to any device from which a communication originates, and a “receiving” device or “target” device refers to any device to which a communication is directed.

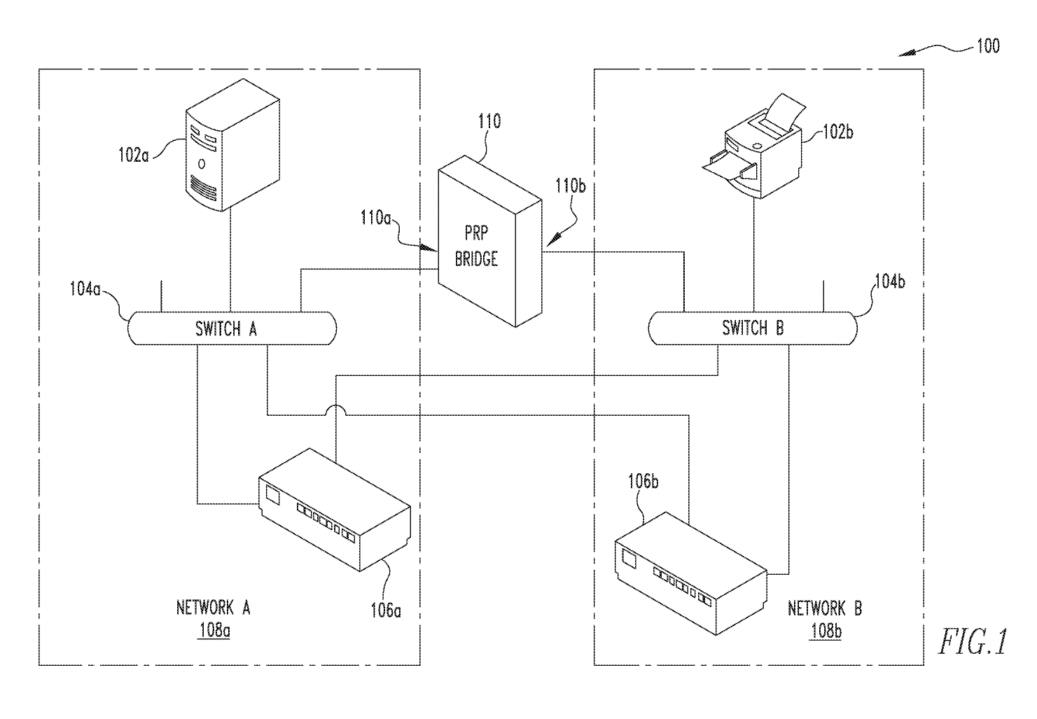

FIG. 1 is an illustrative schematic diagram of an exemplary system 100 including two redundancy networks bridged by a PRP bridge device, in accordance with an embodiment of the disclosed concept. In a non-limiting example embodiment, system 100 includes a first network 108a—“Network A” —and a second network 108b—“Network B.” First network 108a and second network 108b may, for instance, correspond to any suitable network including, but not limited to, local area networks (“LAN”), wide area networks (“WAN”), telephone networks, wireless networks, point-to-point networks, star networks, token ring networks, hub networks, and/or ad-hoc multi-hop networks. In one embodiment, both networks 108a and 108b are redundant PRP networks structured to operate using PRP protocols, as defined by IEC 62439-3, clause 4.

In the illustrative embodiment, network 108a includes a first single attached device 102a, a first switch 104a, and a first dual attached device 106a. First single attached device 102a, which may also be referred to as a single attached node (“SAN”), in one embodiment, may correspond to any suitable device attached to first network 108a. Typically, a single attached device will is restricted such that it is only able to communicate with other devices (either dual attached devices or other single attached devices) of the same network (e.g., first network 108a). Various examples of single attached devices include, but are not limited to, Precision Time Protocol (“PTP”) clocks, printers, laptops, and/or any other standard IT device. Generally, a single attached device corresponds to any device that does not support the PRP protocol.

First switch 104a, in one embodiment, corresponds to a computing device structured to receive, process, and send data to a destination device. Persons of ordinary skill in the art will recognize that any suitable type of switch may be employed within system 100. Furthermore, first switch 104a may be a multilayered switch, and may be structured to operate any suitable communications protocol (e.g., IEEE 802.1D, IEEE 802.1w, IEEE 802.1aq, IEEE 802.1s).

Dual attached device 106a, in one embodiment, corresponds to any suitable device structured to be in communication with both networks 108a and 108b via first switch 104a and second switch 104b, respectively. Generally, dual attached devices or nodes (“DAN”) are structured to include two data ports operating in parallel, which are both in communication with an upper layer of a communications stack via a link redundancy entity (“LRE”). When a data packet, which may also be referred to as an Ethernet frame or a frame, is sent by an upper layer protocol of a DAN, the LRE duplicates the data packet and causes the data ports to each output one of the data packets. The two data packets (e.g., the original and the duplicate) are sent out to the destination device across both networks that the DAN is attached to. When sending the data packets, the LRE appends each data packet to include a 32-bit redundancy control trailer (“RCT”), which the LRE of a destination device also is structured to remove upon receipt. Both data ports of the DAN (e.g., dual attached device 106a) have a same media access control (“MAC”) address and a single IP address.

In the illustrative embodiment, network 108b includes a second single attached device 102b, a second switch 104b, and a second dual attached device 106b. Network 108b, second single attached device 102b, second switch 104b, and second dual attached device 106b, in one embodiment, are substantially similar to network 106a, first single attached device 102a, first switch 104a, and first dual attached device 106a, and the aforementioned description may apply. For instance, second dual attached device 106b, in the illustrated embodiment, is in communication with both network 108b via switch 104b, and network 108a via switch 104a.

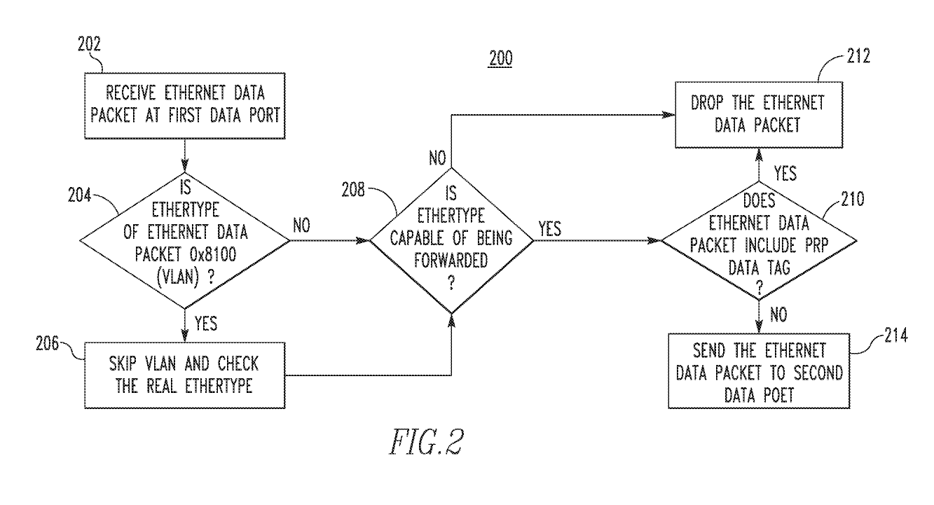

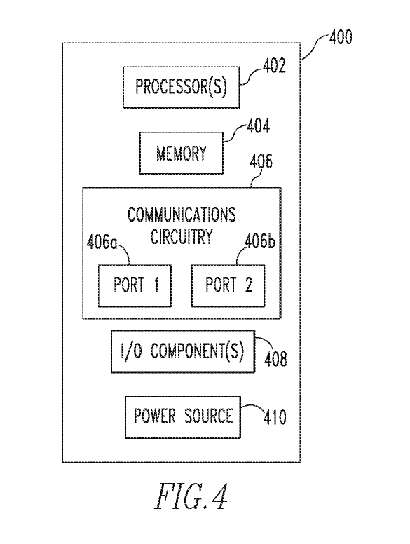

PRP bridge device 110, in a non-limiting embodiment, allows first single attached device 102a of first network 108a to communicate with second single attached device 102b of second network 108b. PRP bridge device 110, which is described in greater detail below with reference to FIG. 4, includes two data ports—one data port in communication with first network 108a and one data port in communication second network 108b. When a data packet is received at one of the data ports of PRP bridge device 110, a filtering mechanism is employed that determines whether or not the data packet includes a PRP data tag (e.g., a data tag inserted into the data packet indicating that the data packet was generated from a PRP device). If so, then PRP bridge device 110 prevents that data packet from being forwarded to the adjacent network coupled to the other data port (e.g., the data port of PRP bridge device 110 that did not receive the data packet). However, if the data packet is determined to not include a PRP data tag, and the value of the EtherType header is one of the values that the PRP bridge is structured to accept (as described in greater detail below with reference to FIG. 2), then PRP bridge device 110 will forward that data packet to the adjacent network. For example, if a first data port 110a of PRP bridge device 110 receives a data packet from first switch 104a, then PRP data bridge device 110 may analyze the received data packet to determine if the data packet includes a PRP data tag. If so, then PRP bridge device 110 may discard, or otherwise prevent, the data packet from being sent to second network 108b. If not, then PRP bridge device 110 may cause the data packet to be forwarded to switch 104b via a second data port 110b, which is in communication with second network 108b.

Generally, PRP bridge device 110 allows single attached devices of different PRP networks to communicate with one another. In particular, system 100 need not include a redundancy box, which allows the implementation of system 100 to conserve resources and, generally, link network 108a and 108b.

FIG. 2 is an illustrative flowchart of an exemplary process 200 for determining whether a data packet received by a first port of a PRP bridge device coupled to a first network is to be forwarded to a second port of the PRP bridge device coupled to a second network, in accordance with an embodiment of the disclosed concept. Process 200, in a non-limiting embodiment, begins at step 202. At step 202, an Ethernet data packet is received at a first data port of a PRP bridge device. For example, a data packet may be received by first data port 110a of PRP bridge device 110. Ethernet data packets, in one embodiment, are binary data strings specified by the IEEE 802.3 communications protocol. Data packets of this protocol may include a preamble, a header field indicating source and destination MAC addresses and an Ethertype, a payload, and a frame check sequence, however additional fields may also be included.

At step 204, a determination is made as to whether or not the Ethernet data packet that was received has an Ethertype of 0x8100 (VLAN). VLAN, or virtual LAN, are data link layer constructs. The VLAN, or 802.1Q, tag is located, if included within the Ethernet data packet, between the source's MAC address field and the Ethertype field. The VLAN tag is 4 octets in length, with the first two octets being a Tag Protocol Identifier (“TPID”) of 0x8100. The location of the TPID is of the same place as the Ethertype tag in a non-VLAN tag Ethernet data packet. Therefore, the presence of the 0x8100 value indicates that the data packet includes an IEEE 802.1Q VLAN tag, in which case the next two octets of the VLAN tag indicate the Tag Control Information (“TCI”). Persons of ordinary skill in the art will recognize that the presence of an 0x9100 Ethertype, indicating double VLAN tagging, as well as similar headers that may be inserted in the Ethernet header may also be employed, and the aforementioned determination of whether a received Ethernet data packet has an Ethertype of 0x8100 (VLAN) is merely exemplary.

If, at step 204, it is determined that the Ethertype of the received data packet is of the 0x8100 Ethertype, then process 200 proceeds to step 206. At step 206, the VLAN tag is skipped, and the real Ethertype of the data packet is checked. The Ethertype is a two octet field within the data packet located between the source's MAC address field and the payload field. The Ethertype indicates a protocol of the payload field, and uses the IEEE 802.3 standard. After checking the Ethertype in step 206, process 200 proceeds to step 208. Furthermore, if at step 204 it is determined that the Ethertype of the received data packet is not of the 0x8100 Ethertype (e.g., does not include a VLAN tag), then process 200 proceeds to step 208.

At step 208, a determination may be made as to whether the Ethertype of the Ethernet data packet is one of the Ethertypes that the PRP bridge device is structured to forward (e.g. 0x0800 (IPv4), 0x0806 (ARP), 0x86DD (IPv6), or 0x8035 (RARP)). The Ethertype is a two octet field, as mentioned previously, located between the source's MAC address field and the payload field for non-VLAN tagged data packets, and between the 802.1Q (VLAN) field and the payload field for VLAN tagged data packets. Data packets may be of different Ethertype, and persons of ordinary skill in the art will recognize that 0x0800 (IPv4), 0x0806 (ARP), 0x86DD (IPv6), and 0x8035 (RARP) are exemplary.

If, at step 208, it is determined that the data packet has an Ethertype corresponding to one of the protocols process 200 is structured to forward, such as, and without limitation, 0x0800 (IPv4), 0x0806 (ARP), 0x86DD (IPv6), or 0x8035 (RARP), then process 200 proceeds to step 210. If, however, at step 208, it is determined that the data packet does not have an Ethertype corresponding to one of the protocols that the PRP bridge device is capable of forwarding, then process 200 proceeds to step 212. At step 212, the Ethernet data packet is dropped such that the Ethernet data packet will not be sent the second data port of the PRP bridge for forwarding to the other PRP network. For example, if the data packet received at first data port 110a of PRP bridge 110 has an Ethertype differing from one of the protocols that the PRP bridge device is structured to forward (e.g., 0x0800 (IPv4), 0x0806 (ARP), 0x86DD (IPv6), or 0x8035 (RARP)), then PRP bridge 110 may cause the data packet to be dropped. In this way, the Ethernet data packet will not be sent to second network 108b. In one embodiment, dropping the data packet corresponds to deleting or otherwise discarding the data packet.

At step 210, a determination is made as to whether the Ethernet data packet includes a PRP data tag. As mentioned previously, when a dual attached device duplicates a data packet for transmission along both networks that it belongs to, the LRE of the dual attached device appends the data packet to include a 32-bit redundancy control trailer (“RCT”). The LRE of a receiving dual attached device is also structured to remove the RCT upon receipt of the data packet (e.g., the original or the duplicate, which ever arrives first). Generally, the RCT includes a 16-bit sequence number, a 4-bit LAN identifier, and a 12-bit frame size. Padding may, for example, also be included within the RCT. The RCT is inserted, in one embodiment, between the payload field and the FCS field. PRP bridge device 110, therefore, is able to determine whether the Ethernet data packet received at its first data port (e.g., first data port 110a) includes a PRP data tag based on the presence of the RCT.

If, at step 210, PRP bridge device 110 determines that the received Ethernet data packet includes a PRP data tag, then process 200 proceeds, in one embodiment, to step 212 where the Ethernet data packet is dropped. For instance, if PRP bridge device 110 determines that the received data packet includes a PRP data tag, then this indicates that the data packet originated from a PRP enabled device, such as dual attached device 106a, 106b, and not from a non-PRP enabled device, such as single attached device 102a, 102b. In this particular scenario, the data packet will not need to pass through PRP bridge device 110, as a dual of the data packet has already been sent to the other network (e.g., network 108a, 108b) from the source dual attached device.

However, if at step 210 it is determined that the Ethernet data packet does not include a PRP data tag, then process 200 proceeds to step 214. At step 214, the Ethernet data packet will be sent to the second data port of PRP bridge device 210 such that the Ethernet data packet is able to be sent to the additional network. For example, if a data packet is received by first data port 110a of PRP bridge device 110 from single attached device 102a of first network 108a, then, upon determining that the data packet does not include a PRP data tag, PRP bridge device 110 may send the data packet to second data port 110b such that the data packet may be sent to second network 108b.

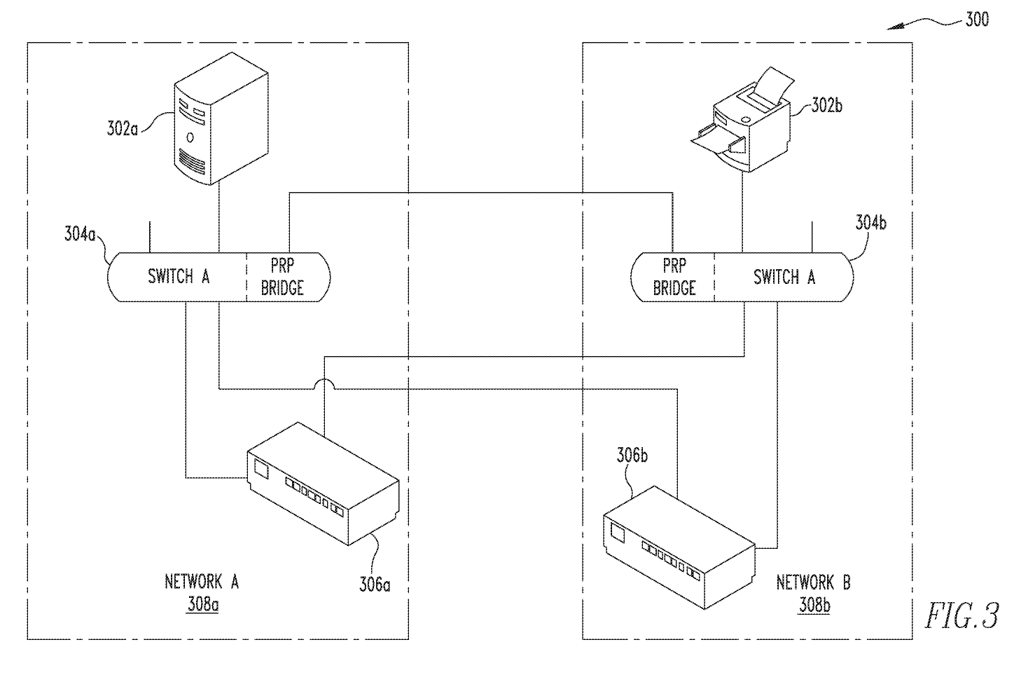

FIG. 3 is illustrative schematic diagram of another exemplary system 300 including two redundancy networks, where each redundancy network includes a switch including PRP bridge functionality, in accordance with an embodiment of the disclosed concept. In a non-limiting example embodiment, the PRP bridge functionality is implemented within a switch, such as within switches 304a and/or 304b of FIG. 3. In this particular scenario, one of the data ports of switch 304a and/or 304b is configured to be in a PRP bridge mode. This would allow a switch to support redundant connection between networks 308a and 308b.

System 300, in the illustrative embodiment, includes a first network 308a—“Network A”—and a second network 308b—“Network B.” In one embodiment, both networks 308a and 308b are redundant PRP networks structured to operate using PRP protocols, as defined by IEC 62439-3, clause 4. In the illustrative embodiment, network 308a includes a first single attached device 302a, a first switch 304a, and a first dual attached device 306a, while network 308b includes a second single attached device 302b, a second switch 304b, and a second dual attached device 306b. In one embodiment, networks 308a and 308b, first and second single attached devices 302a and 302b, and first and second dual attached devices 306a and 306b of FIG. 3 are substantially similar to networks 108a and 108b, first and second single attached devices 102a and 302b, and first and second dual attached devices 106a and 106b of FIG. 1, and the previous description applies.

First and second switches 304a and 304b of FIG. 3 are also substantially similar to first and second switches 104a and 104b of FIG. 1, in one embodiment, with the exception that first and second switches 304a and 304b include the functionality of a PRP bridge device, such as PRP bridge device 110. In this way, a separate PRP bridge device is not necessarily required, as either of, or both of, switches 304a and 304b are capable of functioning as a PRP bridge device such that first single attached device 302a of first network 308a is able to communicate with second single attached device 302b of second network 308b. For instance, switch 304a, 304b is structured to include one data port in communication with first network 308a and one data port in communication second network 308b. When a data packet is received at one of the data ports of switch 304a or 304b, a filtering mechanism is employed that determines whether or not the data packet includes a PRP data tag (e.g., a data tag inserted into the data packet indicating that the data packet was generated from a PRP device). If so, then switch 304a and/or 304b prevents that data packet from being forwarded to the adjacent network coupled to the other data port. However, if the data packet is determined to not include a PRP data tag, and the value of the EtherType header is one of the values that the PRP bridge is structured to accept (as described in greater detail above with reference to FIG. 2), then that switch will forward that data packet to the adjacent network.

FIG. 4 is an illustrative block diagram of an exemplary PRP bridge device 400, in accordance with an embodiment of the disclosed concept. In some embodiments, PRP bridge device 400 corresponds to PRP bridge device 110 of FIG. 1, however in another embodiment, PRP bridge device 400 corresponds to a portion of switches 304a and/or 304b of FIG. 3. For instance, the functionality as described below for PRP bridge device 400 is capable of being incorporated into one or more of switches 304a and 304b such that switches 304a and/or 304b are capable of functioning as a PRP bridge device.

PRP bridge device 400, in a non-limiting embodiment, includes one or more processors 402, memory 404, communications circuitry 406, input/output (“I/O”) component(s) 408, and a power source 410. PRP bridge device 400 also, in one embodiment, includes additional components, such as a bus connector, switches, and the like. Furthermore, while PRP bridge device 400 includes multiple instances of one or more components, persons of ordinary skill in the art will recognize that this is merely exemplary.

Processor(s) 402, in one embodiment, include any suitable processing circuitry capable of controlling operations and functionality of PRP bridge device 400, as well as facilitating communications between various components within PRP bridge device 400. Various types of processors that processor(s) 402 may correspond to include, but are not limited to, central processing units (“CPU”), graphic processing units (“GPU”), microprocessors, digital signal processors, signal processing gateways (“SPG”), or any other type of processor, or any combination thereof. The functionality of processor(s) 402 is capable of being performed by one or more hardware logic components including, but not limited to, field-programmable gate arrays (“FPGA”), application specific integrated circuits (“ASICs”), application-specific standard products (“ASSPs”), system-on-chip systems (“SOCs”), and/or complex programmable logic devices (“CPLDs”). Furthermore, each of processor(s) 402 is capable of including its own local memory to store program systems, program data, and/or one or more operating systems. However, processor(s) 402 may run an operating system (“OS”) for PRP bridge device 400, and/or one or more firmware applications, media applications, and/or applications resident thereon.

Memory 404, in one embodiment, includes one or more types of storage mediums such as any volatile or non-volatile memory, or any removable or non-removable memory implemented in any suitable manner to store data for PRP bridge device 400. For example, information is capable of being stored using computer-readable instructions, data structures, and/or program systems. Various types of storage/memory include, but are not limited to, hard drives, solid state drives, flash memory, permanent memory (e.g., ROM), electronically erasable programmable read-only memory (“EEPROM”), CD-ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, memory 404 is capable of being implemented as computer-readable storage media (“CRSM”), corresponding to any available physical media accessible by processor(s) 402 to execute one or more instructions stored within storage/memory 404.

Communications circuitry 406, in one embodiment, corresponds any circuitry allowing or enabling one or more components of PRP bridge device 400 to communicate with one another, one or more additional devices, servers, and/or systems. In one embodiment, communications circuitry 406 includes a first data port 406a and a second data port 406b, however persons of ordinary skill in the art will recognize that additional data ports may also be included. First data port 406a is capable of allowing PRP bridge device 400 to be in communication with a first network, such as first network 108a of FIG. 1, while second data port 406b is capable of allowing PRP bridge device 400 to be in communication with a second network, such as second network 108b of FIG. 1. Generally, first data port 406a and second data port 406b allow PRP bridge device 400 to communicate with two separate and independent networks, such as two redundancy networks.

In one embodiment, PRP bridge device 400 is structured to operate using one or more of the Hypertext Transfer Protocol (“HTTP”), Transmission Control Protocol and Internet Protocol (“TCP/IP”). PRP bridge device 400 is also capable of communicating with additional networks, systems, and/or devices via a web browser using HTTP. In one embodiment, PRP bridge device 400 includes one or more additional Ethernet ports, or other data port. For instance, an additional Ethernet port may be included by PRP bridge device 400 for a management interface such that statistics, debug information, and/or configurations may be performed for/to PRP bridge device 400. Various additional communication protocols may be used by PRP bridge device 400 to facilitate communications, including, but not limited to, Wi-Fi (e.g., 802.11 protocol), USB, Bluetooth, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network protocol), infrared, FTP, and/or SSH.

In some embodiments, PRP bridge device 400 includes an antenna to facilitate wireless communications with a network using various wireless technologies (e.g., Wi-Fi, Bluetooth, radiofrequency, etc.). In yet another embodiment, PRP bridge device 400 includes one or more universal serial bus (“USB”) ports, one or more Ethernet or broadband ports, and/or any other type of hardwire access port. As an illustrative example, first data port 406a may be a first Ethernet data port and second data port 406b may be a second Ethernet data port. In one embodiment, communications circuitry 406 include an additional data port (e.g., an Ethernet port, USB port, etc.) for diagnostic and management purposes.

PRP bridge device 400 also includes, in one embodiment, I/O component(s) 408. I/O component(s) 408 corresponds to any suitable component or components including, but not limited to, speakers, displays, lights, and the like. For example, PRP bridge device 400 may include one or more LED lights. In one embodiment, each data port (e.g., data ports 406a and 406b) include an LED light that is capable of illuminating a particular color light depending on a status of a network connection associated with that data port. In another embodiment, I/O component(s) 408 may include a relay to indicate whether the device is functional or in an “alarm” state. Using this relay component, an individual can connect a signal through the relay to be notified if the device is off-line, for example.

PRP bridge device 400 furthermore is capable of including a power source 410. Power source 410 may correspond to any suitable device, component, and/or circuitry configured to provide power to PRP bridge device 400. For example, power source 410 may correspond to a physical battery device, and/or may correspond to power circuitry allowing PRP bridge device 400 to receive power (e.g., AC power, DC power) from an external power source.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method, comprising:
receiving, at a first data port of a parallel redundancy protocol (“PRP”) bridge device, a first data packet, the first data port being coupled to a first network;
determining that the first data packet corresponds to a non-PRP data packet; and
sending, using a second data port of the PRP bridge device, the first data packet to a second network coupled to the second data port.

2. The method of claim 1, further comprising:
receiving, at the first data port, a second data packet;
determining that the second data packet corresponds to a PRP data packet; and
preventing the second data packet from being sent to the second network.

3. The method of claim 1, wherein the first network and the second network support PRP network protocols.

4. The method of claim 1, wherein determining that the first data packet corresponds to the non-PRP data packet comprises:
determining an absence of a PRP data tag within the first data packet.

5. The method of claim 1, further comprising:
determining, prior to determining that the first data packet corresponds to the non-PRP data packet, that the first data packet comprises a virtual local area network (“VLAN”) tagged frame; and
causing the VLAN tagged frame to be skipped.

6. The method of claim 1, further comprising:
determining, prior to determining that the first data packet corresponds to the non-PRP data packet, an absence of a virtual local area network (“VLAN”) tagged frame within the first data packet; and
determining that an Ethertype of the first data packet comprises one of a list of protocols capable of being forwarded.

7. The method of claim 6, wherein the list of protocols comprises at least IPv4, ARP, IPv6, and RARP.

8. The method of claim 1, wherein receiving the first data packet comprises:
receiving the first Data packet from a single access device coupled to the first network based, at least in part, an absence of a PRP data tag for the first data packet.

9. A parallel redundancy protocol (“PRP”) bridge device, comprising:
a first data port coupled to a first network;
a second data port coupled to a second network;
memory; and
at least one processor operable to:
determine that a first data packet was received by the first data port;
determine that the first data packet corresponds to a non-PRP data packet;
cause the second data port to send the first data packet to the second network.

10. The PRP bridge device of claim 9, wherein the at least one processor is further operable to:
determine that a second data packet was received by the first data port;
determine that the second data packet corresponds to a PRP data packet; and
prevent the second data packet from being sent to the second network.

11. The PRP bridge device of claim 9, wherein the first network and the second network support PRP network protocols.

12. The PRP bridge device of claim 9, wherein the first data packet being determined to correspond to the non-PRP data packet comprises the at least one processor being further operable to:
determine that there is an absence of a PRP data tag within the first data packet.

13. The PRP bridge device of claim 9, wherein the at least one processor is further operable to:
determine, prior to the first data packet being determined to correspond to the non-PRP data packet, that the first data packet comprises a virtual local area network (“VLAN”) tagged frame; and
cause the VLAN tag to be skipped.

14. The PRP bridge device of claim 9, wherein the at least one processor is further operable to:
determine, prior to the first data packet being determined to correspond to the non-PRP data packet, that there is an absence of a virtual local area network (“VLAN”) tagged frame within the first data packet; and
determine that an Ethertype of the first data packet comprises one of a list of protocols.

15. The PRP bridge device of claim 14, wherein the list of protocols comprises at least IPv4, ARP, IPv6, and RARP.

16. The PRP bridge device of claim 9, wherein the first data packet being received comprises the at least one processor being further operable to:
receive the first data packet from a single access device coupled to the first network based, at least in part, an absence of a PRP data tag for the first data packet.

17. A system, comprising:
a first network comprising at least a first single attached device;
a second network comprising at least a second single attached device; and
a parallel redundancy protocol (“PRP”) bridge device structured to:
receive, at a first data port of the PRP bridge device, a first Data packet, the first data port being coupled to the first network;
determine that the first data packet corresponds to a non-PRP data packet; and
cause, using a second data port of the PRP bridge device, the first data packet to be sent to the second network.

18. The system of claim 17, wherein the first data packet being determined to correspond to the non-PRP data packet comprises the PRP bridge device being further structured to:
determine that there is an absence of a PRP data tag within the first data packet.

19. The system of claim 17, wherein the PRP bridge device is further structured to:
determine, prior to the first data packet being determined to correspond to the non-PRP data packet, that the first data packet comprises a virtual local area network (“VLAN”) tagged frame; and
cause the VLAN tag to be skipped.

20. The system of claim 15, wherein the PRP bridge device is further structured to:
determine, prior to the first data packet being determined to correspond to the non-PRP data packet, an absence of a virtual local area network (“VLAN”) tagged frame within the first data packet; and
determine that an Ethertype of the first data packet comprises one of a list of protocols comprising at least IPv4, ARP, IPv6, and RARP.
